(19) United States
(12) Patent Application Publication
(10) Pub. No.: US 2024/0394269 A1
(43) Pub. Date: Nov. 28, 2024

(54) SERVER AND METHOD FOR APPROXIMATE QUERY PROCESSING BASED ON PROBABILISTIC CIRCUIT

(71) Applicant: ELECTRONICS AND TELECOMMUNICATIONS RESEARCH INSTITUTE, Daejeon (KR)

(72) Inventors: Ki-Hyuk Nam, Daejeon (KR); Sung-Soo Kim, Daejeon (KR); Taewhi Lee, Daejeon (KR); Taek Yong Nam, Daejeon (KR); Choon Seo Park, Daejeon (KR)

(21) Appl. No.: 18/660,439

(22) Filed: May 10, 2024

(30) Foreign Application Priority Data
May 26, 2023 (KR) 10-2023-0068132

(51) Int. Cl. G06F 16/2458; G06N 7/01

(52) U.S. Cl. CPC G06F 16/2462; G06N 7/01

(57) ABSTRACT

Provided are a server and method for approximate query processing based on a probabilistic circuit that improve scalability and efficiency for approximate queries about operations (aggregation, statistics, and the like) mainly used in exploratory data analysis on the basis of a tractable probabilistic circuit (TPC) in a distributed network environment where various terminals (sensors, mobile computing and communication devices, and the like), network devices, and cloud infrastructures autonomously participate and continuously collect data.

### CROSS-REFERENCE TO RELATED APPLICATION

This application claims priority under 35 U.S.C. § 119 to Korean Patent Application No. 10-2023-0068132, filed on May 26, 2023, in the Korean Intellectual Property Office, the disclosure of which is incorporated herein by reference in its entirety.

### BACKGROUND

### 1. Field of the Invention

The present invention relates to a computing device and method for analyzing big data in a distributed network environment using machine learning.

### 2. Description of Related Art

Data required for big data analysis and machine learning, and models created for that purpose are becoming too large to fit in any one place, their speeds are also increasing, and locations from which the data is collected are becoming more diverse. Accordingly, technologies for efficiently analyzing data are being variously developed from traditional statistical techniques to the latest deep machine learning techniques. Particularly, there is active research on approximate query processing, which balances the accuracy and speed of big data analysis for high-dimensional information, such as aggregate or statistical information, techniques for extracting patterns in data using deep machine learning, distributed data storage and processing techniques, distributed machine learning, federated learning, and the like.

Among these various techniques, a tractable probabilistic circuit (TPC) technique allows probabilistic inference on a wide variety of queries. However, there is no proposal on a method of ensuring scalability to efficiently process queries about massive amounts of data spread across distributed environments.

### SUMMARY OF THE INVENTION

The present invention is directed to providing a device and method for approximate query processing that improve scalability and efficiency for approximate queries about operations (aggregation, statistics, and the like) mainly used in exploratory data analysis on the basis of a tractable probabilistic circuit (TPC) in a distributed network environment where various terminals (sensors, mobile computing and communication devices, and the like), network devices, and cloud infrastructures autonomously participate and continuously collect data.

Objects of the present invention are not limited to those described above, and other objects which have not been described will be clearly understood by those of ordinary skill in the art from the following description.

According to an aspect of the present invention, there is provided a server for approximate query processing, the server including a model management unit configured to generate a query response model by training a probabilistic circuit-based model using training data collected by devices included in an approximate query processing network, an inference unit configured to generate, when a query is received, a response to the query using the query response model, and a communication unit configured to transmit the response to a terminal device from which the query is transmitted.

The model management unit may map the devices included in the network to leaf nodes of the probabilistic circuit-based model and generate the probabilistic circuit-based model by configuring sum nodes for binding the same type of data and product nodes for binding different types of data on the basis of information on data types provided by the devices included in the network.

The model management unit may divide the query response model on the basis of a mapping table between the devices included in the network and the nodes of the probabilistic circuit-based model and distribute the divided query response models across the devices included in the network.

The server may further include a query analysis unit configured to extract query pattern information on the basis of the input query.

The model management unit may generate a specialized model configured to handle a specific query on the basis of the query pattern information.

The server may further include a network management unit configured to collect information on the network.

The network management unit may determine a flow priority order for learning and inference of the network on the basis of the information on the network.

The server may further include a network management unit configured to collect information on the network.

The model management unit may update the query response model on the basis of addition and removal information of the network devices included in the information on the network.

According to another aspect of the present invention, there is provided a method of approximate query processing, the method including generating a TPC-based model by mapping devices included in an approximate query processing network to leaf nodes and adding sum nodes for binding the same type of data and product nodes for binding different types of data, generating a query response model by training the probabilistic circuit-based model using training data, and when a query is received, generating a response to the query using the query response model.

The method may further include, when data is added to the network, updating the query response model using the added data.

The method may further include updating the query response model using addition and removal information of the network devices included in information on the network.

The updating of the query response model may include, when a device is added to the network, adding the added device as a new node to the query response model and adjusting a weight of a sum node.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram of a network system for approximate query processing based on a probabilistic circuit according to an exemplary embodiment of the present invention;

FIG. 2 is an example diagram of a probabilistic circuit-based query response model according to the present invention;

FIG. 3 is an example diagram of the network system for approximate query processing based on a probabilistic circuit according to the exemplary embodiment of the present invention;

FIG. 4 is a table showing examples of information on each device included in the network system for approximate query processing according to the present invention;

FIG. 5 is a table showing examples of affiliated devices and network settings of each relay device included in the network system for approximate query processing according to the present invention;

FIG. 6 is a diagram illustrating a process of updating a model that each device included in the network system for approximate query processing according to the present invention has;

FIGS. 7A and 7B are example diagrams of workload information used by an approximate query processing server according to an exemplary embodiment of the present invention;

FIG. 8 is a block diagram of the approximate query processing server according to the exemplary embodiment of the present invention;

FIG. 9 is an example of a node mapping table;

FIG. 10 is a flowchart illustrating a method of approximate query processing based on a probabilistic circuit according to an exemplary embodiment of the present invention; and

FIG. 11 is a block diagram of a computer system for implementing a method according to an exemplary embodiment of the present invention.

### DETAILED DESCRIPTION OF EXEMPLARY EMBODIMENTS

Advantages and features of the present invention and methods of achieving them will become clear with reference to exemplary embodiments described below in detail in conjunction with the accompanying drawings. However, the present invention is not limited to the embodiments disclosed below and may be implemented in various different forms. The embodiments are provided only to make the disclosure of the present invention complete and fully convey the scope of the present invention to those skilled in the technical field to which the present invention pertains, and the present invention is only defined by the scope of the claims. Terminology used herein is for describing the embodiments and is not intended to limit the present invention. In this specification, singular forms also include plural forms unless specifically stated otherwise. As used herein, “comprises” and/or “comprising” specify the presence of constituent elements, steps, operations, and/or devices but do not preclude the presence or addition of one or more other constituent elements, steps, operations, and/or devices.

In describing the present invention, when it is determined that detailed description of related well-known technology will unnecessarily obscure the gist of the present invention, the detailed description will be omitted.

Hereinafter, exemplary embodiments of the present invention will be described in detail with reference to the accompanying drawings. In describing the present invention, to facilitate overall understanding, the same reference numeral will be used for the same element throughout the drawings.

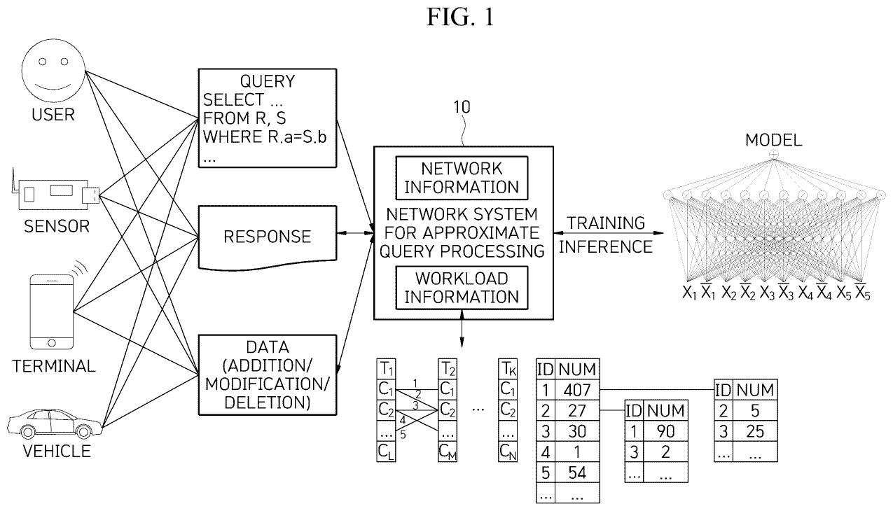

FIG. 1 is a conceptual diagram of a network system for approximate query processing based on a probabilistic circuit according to an exemplary embodiment of the present invention.

A variety of terminal devices 300 (e.g., a sensor, a smartphone, and a smart car) may access a network system 10 for approximate query processing based on a probabilistic circuit according to the present invention (also referred to as a “network system”). A user may access the network system 10 for approximate query processing through an interface provided by the network system 10.

A terminal device 300 or a user accessing the network system 10 for approximate query processing may forward a query about a target to be searched for to the network system 10 to receive a response or may add, modify, or delete data.

The network system 10 for approximate query processing generates a query response model by training a tractable probabilistic circuit (TPC)-based model using current network information (a location, a cost, a response time, a bandwidth, and the like) and workload information (information such as tables collected from queries that have been received, join cases, and the like) on the basis of data collected from one or more terminal devices 300 or users. Examples of the TPC are a sum-product network (SPN), an arithmetic circuit (AC), and a cutset network.

A probabilistic circuit represents a joint probability distribution of given random variables. The probabilistic circuit includes sum nodes, product nodes, and leaf nodes. A leaf node represents the distribution of one random variable, a product node binds different features (columns), and a sum node performs a convex combination of partial circuits composed of the same set of random variables. When inference is possible within a polynomial time because a probabilistic circuit satisfies conditions such as decomposability and the like, the probabilistic circuit is called tractable. Examples of the TPC are an SPN, an AC, and a cutset network.

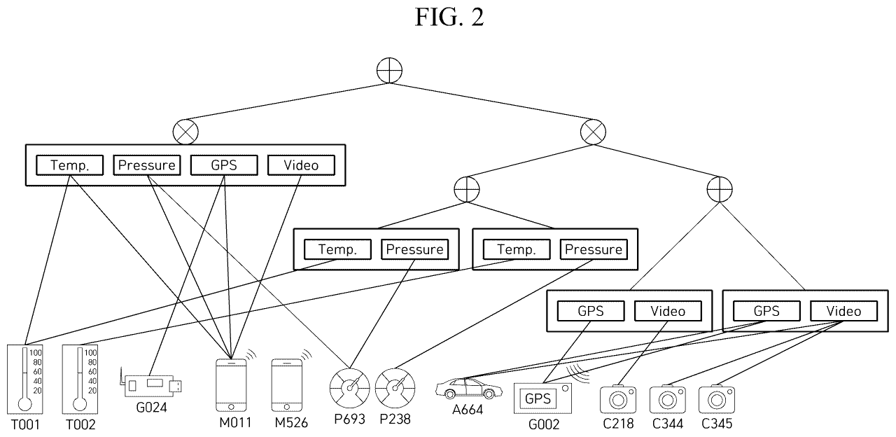

FIG. 2 is an example diagram of a probabilistic circuit-based query response model according to the present invention.

A network system for approximate query processing according to the present invention binds data about different features using a product node and binds data about the same feature using a sum node among data collected by various devices, such as sensors, as shown in FIG. 2. For example, temperature sensor data and pressure sensor data are bound by a product node, and such data collected from area A and area B is bound by a sum node.

The terminal devices 300 connected to the network system 10 for approximate query processing according to the present invention range from low-end sensors to a smartphone, a laptop computer, and the like. Although the key function of the terminal devices 300 is data collection, the terminal devices 300 may also perform training with the collected data or make inferences through a model thereof according to computing resources thereof. A low-end device only for collecting data delegates a training or inference function to a higher-level node. The terminal devices 300 may participate in various nodes according to the types of modules installed therein.

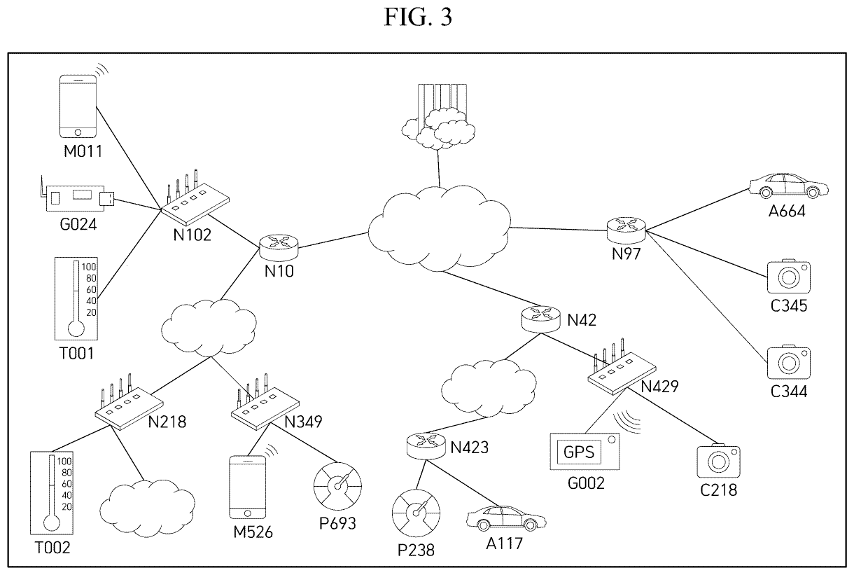

The query response model configured as shown in FIG. 2 is logically represented as one graph, but the actual network is distributed as shown in FIG. 3. Accordingly, the query response model may be divided into sub-models according to a network configuration, and the divided sub-models may be distributed across subnetworks. In this case, data collection, model training, and inference are performed on the basis of such a distributed arrangement.

FIG. 3 is an example diagram of the network system for approximate query processing based on a probabilistic circuit according to the exemplary embodiment of the present invention.

The network system 10 for approximate query processing according to the exemplary embodiment of the present invention includes an approximate query processing server 100, one or more relay devices 200, and one or more terminal devices 300. The approximate query processing server 100 may be referred to as a “central server.”

In FIGS. 3, N10, N42, N97, N102, N218, N349, N423, and N429 correspond to relay devices 200, and A117, A664, C218, C344, C345, G002, G024, M011, M526, P238, P693, T001, and T002 correspond to terminal devices 300.

The approximate query processing server 100 generates, updates, and divides a query response model and distributes the divided query response models across the relay devices 200 and the terminal devices 300 in the network. In this specification, the term “network” means a network included in the network system 10 for approximate query processing. According to the present invention, the query response model which is generated, updated, and managed by the approximate query processing server 100 is a model based on a TPC-based model. The approximate query processing server 100 divides the query response model into an overall model, a summary model, and a specialized model and manages the divided models. The overall model is generated on the basis of all data collected from the terminal devices 300 in the network. The summary model is obtained by integrating all learning models of the entire network on the basis of summarized data of all the data. The specialized model is generated to correspond to a specific join case of a query.

The approximate query processing server 100 generates the query response model by training a TPC-based model using network information (e.g., a topology, nodes, links, flows, locations, costs, a response time, and the like) and workload information (information such as tables included in received queries, join cases, and the like).

The approximate query processing server 100 maps the generated query response model to the devices 200 and 300 in the network. Here, a plurality of nodes included in the query response model may be mapped to one device. Also, one node included in the query response model may be mapped to one device.

The approximate query processing server 100 is logically one server but may physically include one or more computing devices. For example, one approximate query processing server 100 may be physically configured as a plurality of replication servers or a group of servers with a plurality of hierarchies. The approximate query processing server 100 manages the overall query response model based on a probabilistic circuit, network information, and workload information.

The relay devices 200 deploy the divided models in subnetworks and aggregate intermediate results of a query process or inference process. Also, the relay devices 200 may gather data collected from the subnetworks. Examples of the relay devices 200 are typical network devices, such as a router, a switch, and the like, an edge device, and a smartphone with a tethering function. The relay devices 200 according to the present invention are not limited to the foregoing examples. The relay devices 200 update the query response model on the basis of additional data received from affiliated devices or process queries received from subordinate devices. The affiliated devices of the relay devices 200 may be other relay devices 200 or the terminal devices 300. Also, the relay devices 200 may directly perform an inference operation for a query received from a superior device or may distribute the query received from the superior device across subordinate devices, aggregate query response results from the subordinate devices, and then transmit the query response results to the superior device. The relay devices 200 independently process updating of data localized to a local network, resultant updating of the query response model, and inference for queries localized to the local network and synchronize the entire model at certain intervals or idle times. For example, when a query is received from an affiliated device, a relay device 200 determines whether the query is localized to a local network. When the query is localized to a local network, the relay device 200 performs inference for the query using its own query response model. Otherwise, the relay device 200 transmits the query to the superior device.

The detailed time point and intervals of a synchronization operation of the relay devices 200 may be determined according to network operating policies. The approximate query processing server 100 may forward the network operating policies to the relay devices 200 included in the network system 10 for approximate query processing.

Meanwhile, the approximate query processing server 100 may perform not only its unique functions but also functions of the relay devices 200.

The terminal devices 300 transmit collected data to the superior devices 100 and 200. The relay devices 200 receiving the data transmitted from the terminal devices 300 aggregate data of affiliated devices and transmit the aggregated data to the superior devices 100 and 200. When the terminal devices 300 have computing capability, the terminal devices 300 may not only collect data but also train a query processing model and make inferences through the query processing model.

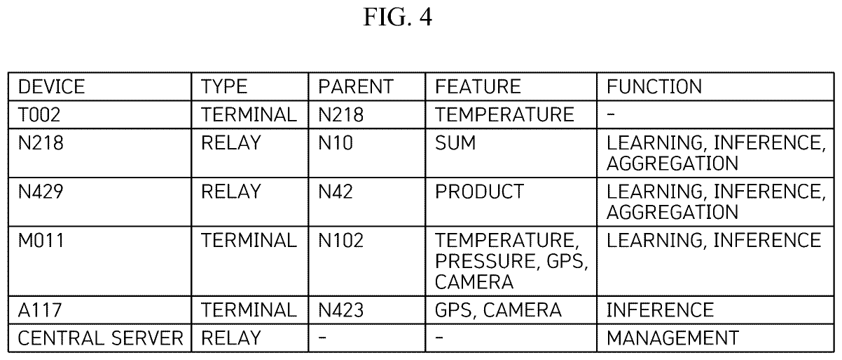

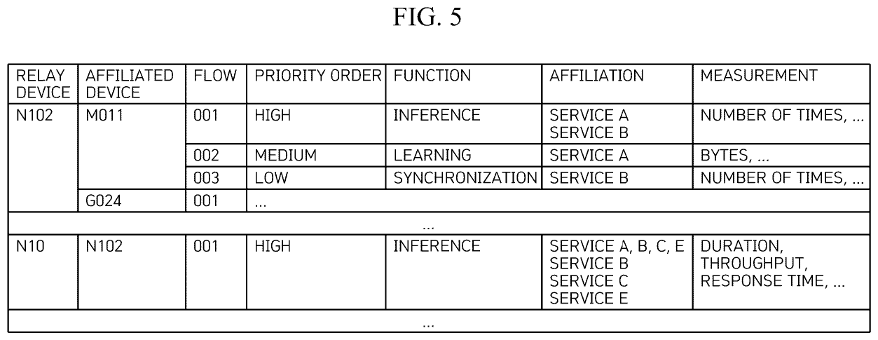

FIG. 4 is a table showing examples of information on each device included in the network system 10 for approximate query processing according to the present invention, and FIG. 5 is a table showing examples of affiliated devices and network settings of each relay device 200 included in the network system 10 for approximate query processing according to the present invention.

FIG. 4 is a network device table showing types, superior nodes, features (sensor types, the types of collected data, node types, and the like), and functions (learning, inference, aggregation, and management) of the devices 200 and 300 included in the network system 10 for approximate query processing. A network management unit 130 collects network information by itself or from a network server 52 and updates the network device table. A model management unit 110 or an inference unit 120 generates a query response model to reflect information (e.g., functions) in the network device table or make an inference using the query response model.

In the present invention, all the relay devices 200 included in the network system 10 for approximate query processing are assumed to control each device logically connected to the network in a centralized manner and be a programmable device. Examples of technology for implementing the assumption are software-defined networking (SDN), network function virtualization (NFV), OpenFlow, programming protocol-independent packet processors (P4), and the like. The relay devices 200 include a controller. The approximate query processing server 100 may collect attributes (response time, latency, throughput, and the like) of a corresponding subnetwork by communicating with the controller in charge of the relay devices 200 in the case of generating the query processing model through training and optimize settings (a path, flow attributes, and the like) of the corresponding subnetwork (see FIG. 5) in the case of deploying the model. The flow attributes may be priority, function, affiliation, measurement, and the like.

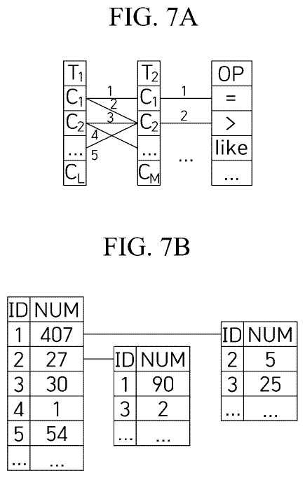

In the exemplary embodiment of FIG. 3, device N102 which is a relay device 200 may provide data flow setting information to affiliated devices M011 and G024 (see FIG. 7). Since device M011 is a device for performing all of training, inference, and synchronization, device N102 sets a high priority for inference of device M011 which is to have a high response time. Since training is processible in the corresponding device, the frequency of exchanging a training request and response is low. Accordingly, a medium priority is set for training. Since an operation of synchronizing a latest learning model and partial models is performed during an idle time within a certain time interval, the lowest priority is set for synchronization.

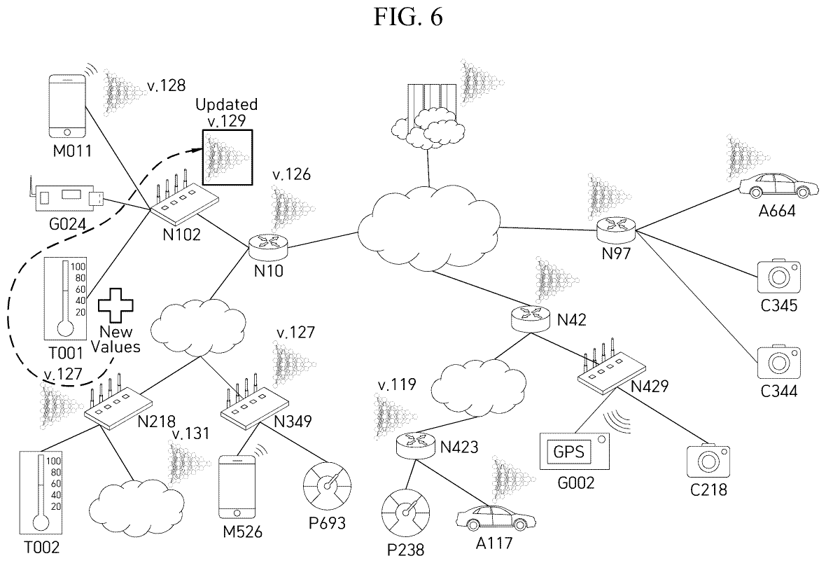

FIG. 6 is a diagram illustrating a process of updating a model that each device included in the network system 10 for approximate query processing according to the present invention has. A process of handling a query and updating a model when devices are disposed in the network as shown in FIG. 6 will be described below.

For example, when devices are disposed as shown in FIG. 6, device M011 which is a terminal device 300 has training and inference capabilities and thus may generate an inference result for a query input by a user using its own model replica and immediately respond. On the other hand, device T001 which is a terminal device 300 is a low-end sensor with insufficient resources and processes a query through superior device N102 which is a relay device 200. Device T001 forwards collected new data to device N102, and device N102 raises a model version by reflecting the new data in an existing model. An update of a query response model based on new data may be, for example, an operation of correcting a probability distribution of leaf nodes included in the model or correcting weights of sum nodes. When the existing model is version v128 and the model updated by device N102 is version v129, device M011 employs the existing model (v128), but device N102 employs the new version (v129). The versions of models that devices included in the network system 10 for approximate query processing have or the versions of models of subnetworks are made the same by synchronization. During a set time interval or idle time, such synchronization may be performed in the approximate query processing server 100. In the present invention, a data change within a synchronization time interval is assumed to follow a non-steep differentiable curve.

A user or terminal device 300 of FIG. 1 transmits a query expressed in structured query language (SQL) text to the approximate query processing server 100 or a relay device 200, and the approximate query processing server 100 or the relay device 200 makes an inference using a previously trained model and then responds to the query on the basis of the inference result. The present invention relates to queries involving operations, such as aggregation (sum, count, or the like) or statistics (average, median, or the like), and it is assumed that simple lookups, exact queries, and the like utilize an existing database. The approximate query processing server 100 collects a key pattern from received queries and adds the key pattern to workload information. A representative example is a join operation. A join operation for the case where values of column C1 of table T1 correspond to values of column C2 of table T2 (“=” operation) may be included in a query. Here, the approximate query processing server 100 newly adds the corresponding case when the case is not present, and increases the frequency of the case when the case is already present. The approximate query processing server 100 utilizes collected workload information in a model training and query optimization process. A method in which the approximate query processing server 100 extracts join information from a query may be understood with reference to FIGS. 7A and 7B.

FIGS. 7A and 7B are example diagrams of workload information used by the approximate query processing server 100 according to the exemplary embodiment of the present invention.

When a given query is “SELECT . . . . FROM T1, T2 WHERE T1.C1=T2.C1,” the approximate query processing server 100 links C1 of table T1 and table T2 and gives a label of 1 to the link (see FIG. 7A). Since an operation used in this case is “=,” the network system 10 for approximate query processing adds the link with the same label to an operation table. In addition to the structure of FIG. 7A for storing connection information, the network system 10 for approximate query processing records the frequency of each connection in a query pattern table (a table including identifier (ID) and number (NUM) columns) of FIG. 7B. Here, an ID is a label given to a link of the structure of FIG. 7A. Referring to FIG. 7B, it is seen that a join combination 1 of given queries has been requested 407 times. When the same combination is added, the approximate query processing server 100 increases the value to 408. Also, a join case may have several conditions. Accordingly, a combination added together with a first combination is additionally stored and the combinations are connected to each other. In the query pattern table of FIG. 7B, an item of which (ID, NUM) is (1, 407) has been received together with a second label combination. In this case, the frequency is 5. In other words, when the predicate of a given query is “T1.C1=T2.C1 and T1.C1>T2.C2,” the approximate query processing server 100 increases the item (2, 5) linked with (1, 407) to (2, 6). When a combination which has not been present is received, the corresponding item is added to the workload information (e.g., a link between tables).

The recorded workload information is used for training on join cases in a subsequent process in which the approximate query processing server 100 generates a query response model by training a probabilistic circuit-based model. In other words, the approximate query processing server 100 basically generates a query response model in the form of a graph for each table, but when a join frequency is very high, the probabilistic circuit-based model may be trained using data reflecting the corresponding combination to generate a query response model for the combination. In this specification, a query response model which is generated using data reflecting a specific join combination is referred to as a “specialized model.” The range or degree of reflecting join cases is adjusted using hyperparameters of training according to operating policies.

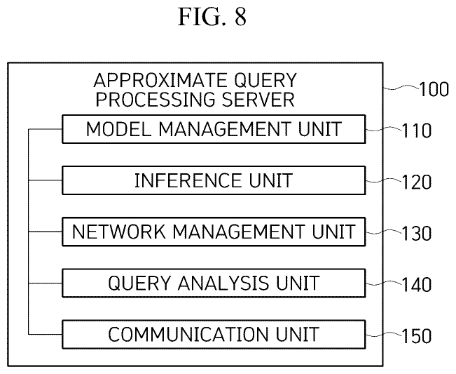

FIG. 8 is a block diagram of the approximate query processing server 100 according to the exemplary embodiment of the present invention.

The approximate query processing server 100 according to the exemplary embodiment of the present invention includes a model management unit 110, an inference unit 120, a network management unit 130, a query analysis unit 140, and a communication unit 150. Here, the network management unit 130 or the query analysis unit 140 may be omitted. The communication unit 150 transmits and receives data and a model between the approximate query processing server 100 and a device included in the network of the network system 10 for approximate query processing.

The model management unit 110 may use an external machine learning server 51 to perform a detailed operation for executing a machine learning algorithm. For example, the machine learning server 51 is a server equipped with a graphics processing unit (GPU). The model management unit 110 generates a query response model (an overall model, a summary model, and a specialized model) using training data collected from the network devices 200 and 300 of the network system 10 for approximate query processing and updates the query response model to reflect data addition of each terminal device 300, data distribution changes, addition and removal of a network device 200 or 300, and the like. The model management unit 110 divides the query response model on the basis of a node mapping table and distributes the divided query response models across the network devices 200 and 300.

The network management unit 130 may use the external network server 52 which recognizes addition or removal of a device in the network of the network system 10 for approximate query processing. For example, the network server 52 is a server that supports programmable technology such as SDN, OpenFlow, or the like. The network management unit 130 collects network information of the network system 10 for approximate query processing, and adjusts the priority order of a network flow for inference or learning of the network system 10 for approximate query processing on the basis of the network information. The network management unit 130 may collect network information of the network system 10 for approximate query processing by itself or from the network server 52. Also, the network management unit 130 transmits the priority order of the network flow to the network server 52 so that the approximate query processing server 100 can efficiently communicate with the network devices 200 and 300 in an inference or learning process.

The approximate query processing server 100 generates, updates, and divides a TPC-based query response model and distributes the divided query response models across the relay devices 200 and the terminal devices 300 in the network. The approximate query processing server 100 may generate an inference result for a query using the generated query response model. In the present embodiment, it is assumed that a TPC based on which the approximate query processing server 100 generates a query response model is a sum-product network (SPN).

Operations of the approximate query processing server 100 are classified into four operations: initialization S1, model update S2, model use S3, and optimization S4. When operation S1 is finished, any one of operations S2, S3, and S4 may be performed. S2, S3, and S4 are interchangeable. In other words, under a certain condition, after operation S2 is finished, operation S3 or S4 may be performed, and after operation S3 is finished, operation S2 or S4 may be performed. Also, under a certain condition, after operation S4 is finished, operation S2 or S3 may be performed.

### Initialization S1

The initialization operation S1 is divided into a node configuration operation S11 and an initial learning operation S12.

In the node configuration operation S11, the approximate query processing server 100 sets leaf nodes and then generates product nodes and sum nodes connected to the leaf nodes, constructing a probabilistic circuit model.

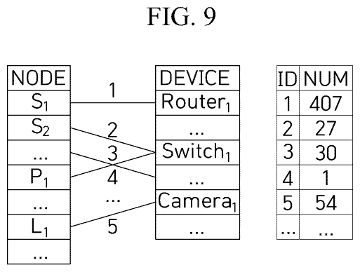

The network management unit 130 periodically updates network information of the network system 10 for approximate query processing and forwards the network information to the model management unit 110. The model management unit 110 maps the leaf nodes of the probabilistic circuit to actual devices included in the network of the network system 10 for approximate query processing on the basis of the network information of the network system 10 for approximate query processing according to certain mapping policies and generates a node mapping information table (see FIG. 9).

Examples of the mapping policies of the model management unit 110 are given below.

(1) One sensor measurement value is represented as one univariate probability distribution node. For example, a temperature sensor may be represented as a leaf (temperature) node.

(2) A plurality of sensors installed in one device may be represented as one multivariate probability distribution node or separately represented as a plurality of univariate probability distribution nodes. For example, a smartphone may be represented as Leaf (Global Positioning System (GPS), Cam, Pres, Temp) which is one multivariate probability distribution node or separately represented as Leaf (GPS), Leaf (Cam), Leaf (Pres), Leaf (Temp), and the like which are four univariate probability distribution nodes.

A location in a physical network and a location in a probabilistic circuit are independent of each other. For example, when a plurality of sensors are installed in one device, information collected from the plurality of sensors may be separately bound by different intermediate nodes (sum or product). Also, devices connected to different switches may be bound by the same node. The model management unit 110 binds leaf nodes on the basis of operation efficiency and communication efficiency.

In a probabilistic circuit, a product node is used for binding different types of data. An initial default configuration is a product node for binding types of data, and there are no duplicate types in the configuration of the product node.

In a probabilistic node, a sum node is used for binding the same type of data. An initial default configuration reflects a network topology and is for binding nodes having the same type of data among a plurality of nodes connected to one switch. When a sum node is configured, types of data which are not identical are not bound together. The model management unit 110 sets a flow for network devices mapped to a sum node on the basis of operation efficiency. For example, the priority order of packets may be set to favor learning and inference of the sum node.

The model management unit 110 may configure nodes of the probabilistic circuit to best reflect the current network structure and attributes according to a policy for configuring nodes in favor of probabilistic circuit computation.

When an initial node configuration of a probabilistic circuit is completed by determining product and sum nodes for binding leaf nodes of the probabilistic circuit, the initial learning operation S12 is performed.

In the initial learning operation S12, with initial nodes of the probabilistic circuit configured, the model management unit 110 generates a query response model by performing parameter learning using training data. In this operation, the model management unit 110 sets only parameters (weights of sum nodes and a distribution of leaf nodes) without changing the structure of the probabilistic circuit. The training data is data which is collected or aggregated by the network devices 200 and 300 of the network system 10 for approximate query processing and transmitted to the approximate query processing server 100.

The model management unit 110 may divide and distribute the query response model across the network devices 200 and 300 of the network system 10 for approximate query processing.

### Model Update S2

The model update operation S2 is performed when data is added to a specific terminal node S21 or a device is added to or removed from the network S22.

In the case S21 where data is added to a specific terminal node, when data is added to an existing distribution, training (model update) is only performed on a portion corresponding to the added data in the existing distribution.

In the case S21 where data is added to a specific terminal node, when the existing distribution changes, each of the devices 200 and 300 in the network recursively forwards the distribution change to a superior (sum or product) node according to preset mapping relationships. In this way, the distribution change is transmitted to the approximate query processing server 100. Information on the distribution change is propagated asynchronously during a network idle time. In other words, even when the distribution changes at a specific terminal node, information on the distribution change is stored in a queue and reflected in a model update during a network idle time.

In a model update, when a superior node is a sum node, the model management unit 110 determines whether to adjust a weight and then updates the model. As the weight, a value obtained by normalizing the number of training times may be used. When the superior node is a product node, the model management unit 110 forwards the information to the superior node. When the superior node is the approximate query processing server 100, the model management unit 110 updates the query pattern table (see FIG. 7B) and a node mapping table (see FIG. 9).

The model management unit 110 updates the summary model to reflect the changed data. The model management unit 110 may update a specialized model (a join-case-reflecting model or the like) according to a changed query pattern and changed node mapping information. Also, the model management unit 110 transmits the summary model to devices corresponding to subordinate nodes through the communication unit 150. The summary model transmission operation is asynchronously processed during a network idle time.

Next is the case S22 where a device is added to or removed from the network. When a device is added to or removed from the network, the network management unit 130 forwards device change information to the model management unit 110, and the model management unit 110 adds or removes a node to or from the probabilistic circuit-based query response model. The network management unit 130 may collect device change information by itself or from the network server 52. In other words, the network management unit 130 or the network server 52 may periodically detect addition or removal of a device to or from the network. The network server 52 notifies the approximate query processing server 100 of the device change information. The network management unit 130 manages the number (count) of devices in the network. When a new device is added, the count increases by one. When a sum node is added, the model management unit 110 sets a weight to a ratio obtained by normalizing the count. The network management unit 130 updates network configuration information on the basis of the device change information. The model management unit 110 updates the query response model on the basis of the device change information and forwards the summary model and/or specialized model to each device in the network through the communication unit 150.

The model management unit 110 may divide the query response model which is updated in the model update operation S2 and distribute the divided query response models across the network devices 200 and 300 of the network system 10 for approximate query processing.

### Model Use S3

The inference unit 120 and the query analysis unit 140 receive a query transmitted from a terminal device 300 in the network through the communication unit 150. The query analysis unit 140 records query history in an internal storage. The query history is recorded to extract a query pattern. A tensor may be used as a structure for recording query history. For example, query history may be recorded on a three-dimensional (3D) tensor having a size of the number of columns in table R*the number of columns in table S*an operation type (a single table, inner join, or outer join operation). The query analysis unit 140 analyzes the stored query history and extracts query pattern information. The query pattern information is information on tables and columns included in queries and join relationships (none, inner, outer) between the columns.

The inference unit 120 generates a response to the query through inference using the query response model (the overall model or summary model). The inference unit 120 transmits the response to the terminal device 300 that has transmitted the query through the communication unit 150.

For reference, when a relay device 200 in the network of the network system 10 for approximate query processing receives the query and has a summary model, the relay device 200 may make an inference using the summary model and transmit a response to the terminal device 300 that has transmitted the query without sending the query to a superior node in the network.

When the inference unit 120 has no summary model, the inference unit 120 extracts actual network devices mapped to nodes in the query response model on the basis of the node mapping table, queries the network devices, and aggregates the responses to generate a final query response. For example, when a query is about features (columns) A and B, the inference unit 120 extracts a sum node and a product node connected to leaf node A and leaf node B in the probabilistic circuit-based query response model and extracts actual network devices 200 and 300 mapped to the sum and product nodes using the node mapping table.

The inference unit 120 divides the query for each node and transmits the divided queries through the communication unit 150. When a trained model is present in the uppermost node among partial nodes, a device 200 or 300 corresponding to the uppermost node may immediately generate a response and transmit the response to the terminal device 300 that has transmitted the query, directly or through the approximate query processing server 100.

When no trained model is present in the uppermost node among the partial nodes, the inference unit 120 transmits the divided queries to the terminal devices 300 through the communication unit 150 and aggregates the responses to generate a final response. The inference unit 120 transmits the final response to the terminal device 300 that has transmitted the query, through the communication unit 150.

### Optimization S4

The optimization operation S4 may be divided into a summary model management operation S41, a specialized model generation operation S42, a query pattern update operation S43, and a node mapping update operation S44.

The summary model management operation S41 relates to generation, update, and synchronization of a summary model. Each of the network devices 200 and 300 locally updates a query response model on the basis of an initial summary model. Each of the network devices 200 and 300 of the network system 10 for approximate query processing may have a version of the summary model obtained by asynchronously merging partial learning aggregation versions of the summary model. When a specific node has large variation (when it is necessary to change weights of a sum node and the structure), a relay device 200 notifies the model management unit 110 of the approximate query processing server 100 of that so that the model management unit 110 updates the summary model with the latest version. The model management unit 110 synchronizes the updated overall summary version in an asynchronous manner during a network idle time.

The specialized model generation operation S42 relates to an operation of a specialized model for responding to a specific form of query such as INNER JOIN. It is inefficient to train a model every time in consideration of all join cases. Therefore, the model management unit 110 may separately generate a learning model reflecting join cases with a certain frequency or more or the top k join cases (e.g., temperature*pressure, GPS*time) among join cases sorted by frequency. When there is a specialized model corresponding to a join case of an input query, the inference unit 120 may directly generate a response using the specialized model. A join case may be considered a type of query pattern information.

Meanwhile, the query analysis unit 140 periodically extracts query pattern information by analyzing query history stored in the internal storage and updates the query pattern table (S43). The query pattern information is information on tables and columns included in queries and join relationships (none, inner, outer) between the columns.

The model management unit 110 updates the node mapping table (sum and product nodes—network devices) on the basis of network information provided by the network management unit 130.

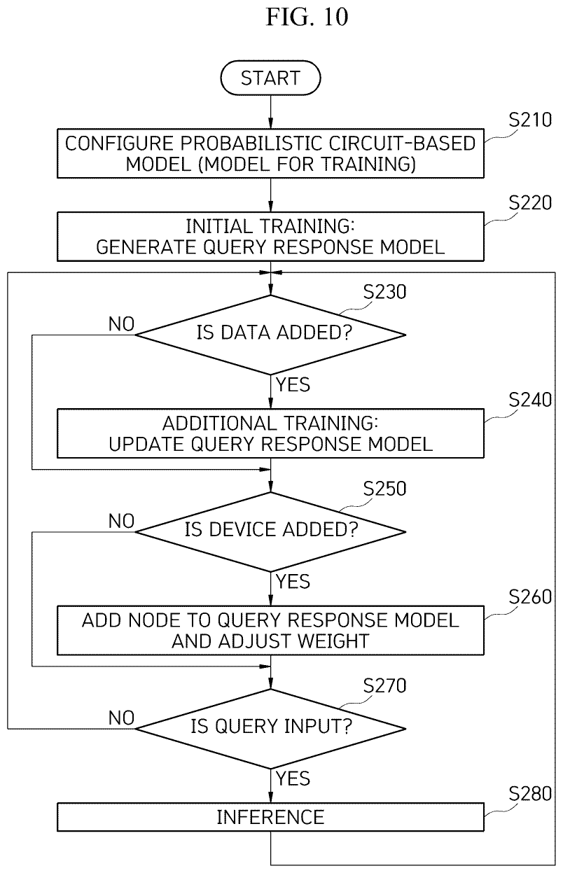

FIG. 10 is a flowchart illustrating a method of approximate query processing based on a probabilistic circuit according to an exemplary embodiment of the present invention.

Referring to FIG. 10, the method of approximate query processing based on a probabilistic circuit according to the exemplary embodiment of the present invention includes operations S210 to S280. The method of approximate query processing based on a probabilistic circuit according to the exemplary embodiment of the present invention is performed by the approximate query processing server 100. The method of approximate query processing based on a probabilistic circuit illustrated in FIG. 10 is in accordance with the exemplary embodiment, and operations of the method of approximate query processing based on a probabilistic circuit according to the present invention are not limited to the exemplary embodiment illustrated in FIG. 10 and may be added, changed, or removed as necessary.

Operation S210 is a probabilistic circuit-based model (learning model) configuration operation. The approximate query processing server 100 configures nodes of a probabilistic circuit-based model. The probabilistic circuit-based model may be an SPN. In this case, the approximate query processing server 100 maps leaf nodes of the probabilistic circuit-based model to devices included in the network system 10 for approximate query processing. A location in the physical network and a location in the probabilistic circuit are independent of each other. The approximate query processing server 100 configures product nodes of the probabilistic circuit-based model, which bind different types of data. Also, the approximate query processing server 100 configures sum nodes of the probabilistic circuit-based model, which bind the same type of data. The approximate query processing server 100 configures the probabilistic circuit-based model to reflect the current network structure and attributes.

Operation S220 is an initial learning operation, in which a query response model is generated. The approximate query processing server 100 performs parameter learning with the initial node configuration of the probabilistic circuit-based model. Here, only parameter setting is performed without any structural change.

Operation S230 is an operation of checking whether data is added. The approximate query processing server 100 determines whether data is added and performs operation S240 when data is added, or performs operation S250 otherwise.

Operation S240 is an additional learning operation, in which the query response model is updated.

The approximate query processing server 100 updates the query response model on the basis of the added data. The approximate query processing server 100 performs the update by learning only the data added to an existing distribution. However, when the existing distribution varies, the approximate query processing server 100 performs an update by recursively forwarding the change to a superior (sum or product) node.

Operation S250 is an operation of checking whether a device is added.

The approximate query processing server 100 checks whether a device is added to the network and performs operation S260 when a device is added, or performs operation S270 otherwise.

Operation S260 is an operation of adding a node to the query response model and adjusting a weight.

The approximate query processing server 100 adds a node to the query response model. When a sum node is to be added to the query response model, the approximate query processing server 100 sets a weight to a normalized count ratio.

Operation S270 is an operation of checking whether a query is input.

The approximate query processing server 100 checks whether a query is input and performs operation S280 when a query is input, or performs operation S230 otherwise.

Operation S280 is an inference operation.

The approximate query processing server 100 determines whether there is a join relationship by analyzing the query. When there is a join relationship, the approximate query processing server 100 extracts a pattern and records the pattern in a database. The recorded pattern is used for extracting a key pattern and updating workload information. The approximate query processing server 100 selects a node to be queried and makes an inference. The approximate query processing server 100 transmits an inference result to a user or terminal device 300 that has requested a query response. In this case, the approximate query processing server 100 divides the inference result according to nodes and transmits the divided inference results.

The foregoing method of approximate query processing based on a probabilistic circuit has been described with reference to the flowchart shown in the drawing. For simplicity of description, the method has been illustrated as a series of blocks, but the present invention is not limited to the order of blocks. Some blocks may be performed in a different order from that illustrated herein or performed at the same time as other blocks, and many different branches, flow paths, and sequences of blocks may be implemented that achieve the same or similar results. Also, not all the illustrated blocks may be required for implementing the method described herein.

In the description of FIG. 10, according to implementation of the present invention, each operation may be subdivided into additional operations, or the operations may be combined into fewer operations. As necessary, some operations may be omitted, and the sequence of operations may be changed. Also, the descriptions of FIGS. 1 to 9 may be applied to FIG. 10 even when not specifically described. The description of FIG. 10 may likewise be applied to the descriptions of FIGS. 1 to 9.

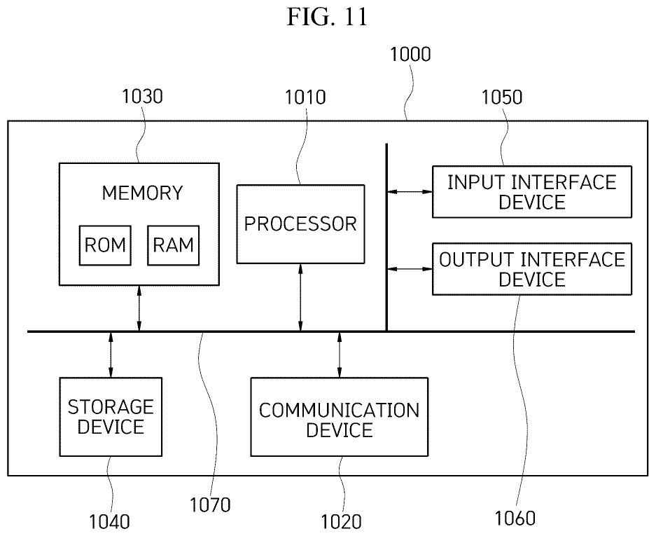

FIG. 11 is a block diagram of a computer system for implementing the method of approximate query processing based on a probabilistic circuit according to an exemplary embodiment of the present invention. The approximate query processing server 100 according to the present invention may be implemented in the form of the computer system of FIG. 11.

Referring to FIG. 11, a computer system 1000 may include at least one of at least one processor 1010, a memory 1030, an input interface device 1050, an output interface device 1060, and a storage device 1040 that communicate through a bus 1070. The computer system 1000 may further include a communication device 1020 coupled to a network. The processor 1010 may be a central processing unit (CPU) or a semiconductor device for executing computer-readable instructions stored in the memory 1030 or the storage device 1040. The memory 1030 and the storage device 1040 may include various forms of volatile or non-volatile storage media. For example, the memory 1030 may include a read-only memory (ROM) and a random-access memory (RAM). According to embodiments of the present disclosure, the memory 1030 may be present in or out of the processor 1010 and connected to the processor 1010 through various well-known devices. The memory 1030 is one of various forms of volatile or non-volatile storage media. For example, the memory 1030 may include a ROM or RAM.

Therefore, an exemplary embodiment of the present invention may be implemented as a method by a computer or as a non-transitory computer-readable medium in which computer-executable instructions are stored. In an exemplary embodiment, when executed by the processor 1010, the computer-readable instructions may perform a method according to at least one aspect of the present disclosure.

The communication device 1020 may transmit or receive a wired signal or wireless signal. The communication device 1020 receives a query from an external terminal device and transmits a response to the query to the terminal device.

Also, a method according to an embodiment of the present invention may be implemented in the form of program instructions that are executable by various computing devices and recorded on a computer-readable medium.

The computer-readable medium may include program instructions, data files, data structures, and the like solely or in combination. The program instructions recorded on the computer-readable medium may be specially designed and prepared for embodiments of the present invention or may be instructions which are well-known and available to those skilled in the field of computer software. The computer-readable medium may include a hardware device configured to store and execute the program instructions. Examples of the computer-readable medium may be magnetic media, such as a hard disk, a floppy disk, and magnetic tape, optical media, such as a compact disc ROM (CD-ROM) and a digital versatile disc (DVD), magneto-optical media, such as a floptical disk, and hardware devices such as a ROM, a RAM, a flash memory, and the like. Examples of the program instructions include machine code generated by a compiler and high-level language code that is executable by a computer using an interpreter or the like.

As described above, the memory 1030 and the storage device 1040 store computer-readable instructions. The processor 1010 is implemented to execute the instructions.

According to an exemplary embodiment of the present invention, by executing the instructions, the processor 1010 generates a query response model by training a probabilistic circuit-based model using training data collected by devices included in an approximate query processing network, and when a query is received, generates a response to the query using the query response model. The communication device 1020 transmits the response to a terminal device from which the query is transmitted.

According to an exemplary embodiment of the present invention, the processor 1010 may map the devices included in the network to leaf nodes of the probabilistic circuit-based model and generate the probabilistic circuit-based model by configuring sum nodes for binding identical types of data and product nodes for binding different types of data on the basis of information on data types provided by the devices included in the network.

According to an exemplary embodiment of the present invention, the processor 1010 may divide the query response model on the basis of a mapping table between the devices included in the network and the nodes of the probabilistic circuit-based model and distribute the divided query response models across the devices included in the network.

According to an exemplary embodiment of the present invention, the processor 1010 may extract query pattern information on the basis of the input query and generate a specialized model for handling a specific query on the basis of the query pattern information.

According to an exemplary embodiment of the present invention, the processor 1010 may collect information on the network and determine a flow priority order for learning and inference of the network on the basis of the information on the network.

According to an exemplary embodiment of the present invention, the processor 1010 may collect information on the network and update the query response model on the basis of addition and removal information of the network devices included in the information on the network.

For reference, components according to exemplary embodiments of the present invention may be implemented in the form of hardware, such as a field-programmable gate array (FPGA) or application-specific integrated circuit (ASIC), which performs certain roles. However, the term “unit” is not meant to be limited to software or hardware.

However, the term “component” is not limited to software or hardware, and each component may be present in an addressable storage medium or configured to operate one or more processors.

Therefore, as an example, “components” include components, such as software components, object-oriented software components, class components, and task components, processes, functions, attributes, procedures, subroutines, segments of program code, drivers, firmware, microcode, circuitry, data, databases, data structures, tables, arrays, and variables.

Components and functionality provided in components may be combined into fewer components or may be further subdivided into additional components.

Here, it will be understood that each block of process flowcharts and combinations of the flowcharts may be performed by computer program instructions. These computer program instructions may be loaded onto a processor of a general-purpose computer, a special purpose computer, or other programmable data processing equipment, and thus the instructions executed by the processor of the computer or other programmable data processing equipment create elements to perform functions described in the block(s) of the flowcharts. These computer program instructions may also be stored in a computer-usable or computer-readable memory that may be directed to a computer or other programmable data processing equipment to implement functionality in a particular way. Accordingly, instructions stored in the computer-usable or computer-readable memory may produce a manufactured item including instruction elements that perform functions described in the flowchart block(s). The computer program instructions may also be loaded on a computer or other programmable data processing equipment. Accordingly, a series of operations is performed on the computer or other programmable data processing equipment to create a computer-executed process so that instructions for operating the computer or other programmable data processing equipment may provide operations for performing functions described in the flowchart block(s).

Additionally, each block may represent a module, a segment, or a portion of code that includes one or more executable instructions for executing specified logical function(s). In some implementation examples, it is also to be noted that functions described in blocks may occur out of order. For example, two blocks shown in succession may be performed substantially concurrently, or the blocks may sometimes be performed in reverse order depending on the corresponding functions.

The term “unit” used in the present embodiment refers to software or a hardware component, such as an FPGA or ASIC, and a “unit” performs certain roles. However, a “unit” is not limited to software or hardware. A “unit” may be configured to be in an addressable storage and configured to operate one or more processors. For example, a “unit” may include components, such as software components, object-oriented software components, class components, and task components, processes, functions, attributes, procedures, subroutines, segments of program code, drivers, firmware, microcode, circuitry, data, databases, data structures, tables, arrays, and variables. Components and functionality provided in “units” may be combined into fewer components and “units” or may be further subdivided into additional components and “units.” In addition, components and “units” may be implemented to operate one or more CPUs in a device or secure multimedia card.

The main features of the present invention are summarized below.

### (1) Improved Learning and Inference Performance Based on Query History

According to a network system and method for approximate query processing according to embodiments of the present invention, a query pattern table is generated on the basis of features (tables and columns) of query targets and join combinations, and query pattern data is managed in order of frequency. Also, a specialized model is created for top query patterns with high frequency during a model training or optimization process and kept in a cache. Using such a specialized model, it is possible to improve model learning and inference performance and provide a rapid response.

### (2) Increased Model Scalability and Efficiency Based on a Distributed Network

A network system and method for approximate query processing according to embodiments of the present invention can extend a model to reflect the configuration of a TPC-based learning model and a network configuration. TPCs show more efficient inference performance than probabilistic graphical models. Since data generated from all the network devices can be compressed in the form of a summary model, it is possible to generate responses to general-purpose queries for various conditions. Also, network scalability can be supported by merging partial models.

Further, it is possible to support the network management unit 130 or a network server to establish network operating policies in favor of learning and inference. The network management unit 130 or network server may determine a network flow (a priority order and the like) to favor an operation flow of a probabilistic circuit on the basis of a node mapping table in which nodes of the probabilistic circuit are mapped to actual network devices (routers, switches, and the like), and provide the network flow to the approximate query processing server 100. In other words, it is possible to adjust a flow priority order in favor of a probabilistic circuit-based model's processing. In other words, the approximate query processing server 100 can configure nodes in consideration of network characteristics (proximity and speed) by associating the probabilistic circuit-based model with a network topology. For example, the approximate query processing server 100 may prioritize binding close nodes that have less communication overhead.

In addition, a network system and method for approximate query processing according to embodiments of the present invention can perform model training and inference as locally as possible and reduce network overhead through distributed/federated learning. Also, it is possible to improve efficiency through asynchronous synchronization in which a summary model is shared among network devices during a network idle time. For example, a sensor node only for measuring a temperature can perform query processing in consideration of other sensor information through a shared summary model.

According to an exemplary embodiment of the present invention, it is possible to process data in a distributed manner even in an environment where it is difficult to collect all data in one spot and store and manage a model trained with the data in one spot.

Specifically, according to an exemplary embodiment of the present invention, a service network graph is divisionally configured with sum nodes and product nodes to recursively perform model training and inference. Accordingly, data collected by a terminal device is not collected at one spot and can be held by each entity, and a learning model is not integrated at one spot and can be distributed across devices or subnetworks to which the devices belong. In this process, the present invention can minimize communication overhead by providing setting information.

Also, according to an exemplary embodiment of the present invention, it is possible to efficiently process model training, distribution, and inference using network information and workload information.

In addition, according to an exemplary embodiment of the present invention, patterns collected from existing query history are used to reflect network information for distributed processing and efficiently learn queries. As a representative example, it is possible to improve performance and accuracy by organizing join cases by combination and frequency and reflecting the organized join cases in a model training operation.

The present invention proposes a method of improving not only scalability but also accuracy in an approximate query processing system to which probabilistic circuit-based machine learning is applied.

For example, application fields of the present invention include distributed machine learning, edge/fog computing, autonomous vehicle management, medical institute and healthcare systems, economic trend analysis, market trend analysis and prediction, and the like.

Effects of the present invention are not limited to those described above, and other effects which have not been described will be clearly understood by those skilled in the technical field to which the present invention pertains from the above description.

Although exemplary embodiments of the present invention have been described above, those skilled in the art will understand that various modifications and alterations can be made without departing from the spirit and scope of the present invention stated in the following claims.

What is claimed is:

1. A server for approximate query processing, the server comprising:
a communication device configured to receive a query from an external terminal device;
a memory configured to store computer-readable instructions; and
at least one processor configured to execute the instructions,
wherein the at least one processor generates a query response model by training a probabilistic circuit-based model using training data collected by devices included in an approximate query processing network, and when a query is received, generates a response to the query using the query response model, and
the communication device transmits the response to the query to a terminal device from which the query is transmitted.

2. The server of claim 1, wherein the at least one processor maps the devices included in the network to leaf nodes of the probabilistic circuit-based model and generates the probabilistic circuit-based model by configuring sum nodes for binding the same type of data and product nodes for binding different types of data on the basis of information on data types provided by the devices included in the network.

3. The server of claim 1, wherein the at least one processor divides the query response model on the basis of a mapping table between the devices included in the network and the nodes of the probabilistic circuit-based model and distributes the divided query response models across the devices included in the network.

4. The server of claim 1, wherein the at least one processor extracts query pattern information on the basis of the input query and generates a specialized model configured to handle a specific query on the basis of the query pattern information.

5. The server of claim 1, wherein the at least one processor collects information on the network and determines a flow priority order for learning and inference of the network on the basis of the information on the network.

6. The server of claim 1, wherein the at least one processor collects information on the network and updates the query response model on the basis of addition and removal information of the network devices included in the information on the network.

7. A method of approximate query processing, the method comprising:
generating a tractable probabilistic circuit (TPC)-based model by mapping devices included in an approximate query processing network to leaf nodes and adding sum nodes for binding the same type of data and product nodes for binding different types of data;
generating a query response model by training the TPC-based model using training data; and
when a query is received, generating a response to the query using the query response model.

8. The method of claim 7, further comprising, when data is added to the network, updating the query response model on the basis of the added data.

9. The method of claim 7, further comprising updating the query response model on the basis of addition and removal information of network devices included in information on the network.

10. The method of claim 9, wherein the updating of the query response model comprises, when a device is added to the network, adding the added device to the query response model as a new node and adjusting a weight of a sum node.
